(19) United States
(12) Patent Application Publication
(10) Pub. No.: US 2015/0066635 A1
(43) Pub. Date: Mar. 5, 2015

(54) Method and process for registration, creation and management of campaigns and advertisements in a network system

(71) Applicants: David Valin, Concord, CA (US); Alex Socolof, Briarcliff Manor, NY (US)

(72) Inventors: David Valin, Concord, CA (US); Alex Socolof, Briarcliff Manor, NY (US)

(21) Appl. No.: 14/467,410

(22) Filed: Aug. 25, 2014

Related U.S. Application Data
(63) Continuation-in-part of application No. 13/171,746, filed on Jun. 29, 2011, now Pat. No. 8,818,850.
Application No. 13/171,746 is a continuation-in-part of application No. 13/282,730, filed on Oct. 27, 2011.
Application No. 13/282,730 is a continuation-in-part of application No. 13/357,029, filed on Jan. 24, 2012.
Application No. 13/357,029 is a continuation-in-part of application No. 12/459,353, filed on Jun. 29, 2009.
Application No. 12/459,353 is a continuation-in-part of application No. 13/360,670, filed on Jan. 28, 2012.

(51) Int. Cl. G06Q 30/02

(52) U.S. Cl. CPC G06Q 30/0276; G06Q 30/0246; G06Q 30/0273
USPC 705/14.45

(57) ABSTRACT

The presented invention is a method for an advertising sponsor user, using a client computer, or mobile device to be able to register, login and create zip code related local sponsor advertisements, with small advertisements for creating interest in the offers, that link to bigger advertisements with an embedded shopping cart. When a user creates the advertisements, they can upload their images, and create their type for the offers in the same interface form and the advertisements are instantly created and able to be published immediately throughout a network. Utilizing zip codes allows the system to use an intelligent smart decision engine, to make decisions of where advertisements and campaigns should be displayed as related to registered users locations. Also past performance and past advertisement information is utilized by the present invention to make appraisal value judgments as to the value of advertisements for sale, and campaign values for sale.

### CROSS REFERENCE TO RELATED APPLICATIONS

This application claims priority from and is a continuation in part of U.S. patent application Ser. No. 13/171,746, entitled “A method and process for registration, creation and management of campaigns and advertisements in a network system”, filed on Jun. 29, 2011, which is incorporated by reference in its entirety for all purposes as if fully set forth herein.

This application claims priority from and is a continuation of U.S. patent application Ser. No. 13/282,730, entitled “Method for Transformation of a Website”, filed on Oct. 27, 2011, which is incorporated by reference in its entirety for all purposes as if fully set forth herein.

This application claims priority from and is a continuation in part of U.S. patent application Ser. No. 13/357,029, entitled “Apparatus for connecting a human key identification to objects and content or identification, tracking, delivery, advertising, and marketing”, filed on 24 Jan. 2012, which is incorporated by reference in its entirety for all purposes as if fully set forth herein.

This application claims priority from and is a continuation in part of U.S. patent application Ser. No. 13/360,670, entitled “Method for connecting a human key identification to objects and content or identification, tracking, delivery, advertising, and marketing”, filed on 28 Jan. 2012, which is incorporated by reference in its entirety for all purposes as if fully set forth herein.

This application claims priority from and is a continuation of U.S. patent application Ser. No. 12/459,353, entitled “Method and mechanism for protection, sharing, storage, accessing, authentication, certification, attachment and tracking anything in an electronic network”, filed on Jun. 29, 2009, which is incorporated by reference in its entirety for all purposes as if fully set forth herein.

### SEQUENCE LISTING OR PROGRAM: Not Applicable

### FEDERALLY SPONSORED RESEARCH: Not Applicable

### TECHNICAL FIELD OF THE INVENTION

The present invention generally relates to a method, executed on a computer system, for the creation and management of campaigns and advertisements. More specifically the present invention relates to a method and process for registration, creation and management of campaigns and advertisements in a network system.

### BACKGROUND OF THE INVENTION

In registration systems currently being used, information is submitted simply into a database without any additional activities at the time of registration. The present invention enables users to do multiple useful tasks at the onset of registration. The present invention further provides advertisers and businesses to connect to users, easily with these registration methods created. Commerce can be conducted between users, and campaigns benefit because a portion of advertisers revenues goes to designated campaigns, enabling everyone who participates to make money. The present invention creates bar codes at the time of registration that enable tracking and fulfillment of transactions.

### DEFINITIONS

Unless stated to the contrary, for the purposes of the present disclosure, the following terms shall have the following definitions:

An advertisement creator module is defined as a software module that is engaged by a user through a computer or other equivalent electronic device to upload media such as images and video to create advertisements follow and predetermined process or protocol.

QR code module is an abbreviation for Quick response code. A QR code module is a specific matrix barcode (or two-dimensional code) that is readable by dedicated QR barcode readers and camera telephones. The code consists of black modules arranged in a square pattern on a white background. The information encoded may be text, URL, or other data. QR codes are automatically created by the QR code module when a user registers, and also are created when a user creates or uploads an advertisement to the system, and are also created when a user creates a campaign in the system, so that each user, advertisement and campaign has attached its own QR code, for use in the system. Also scan able data embedded for decoding in the QR code attached to Users, Advertisements and Campaigns can be changed for the purpose of marketing, relating information, and tracking as the user needs to change it with a QR code administration dashboard editor function.

Payment module is defined as software module that is engaged by a user through a computer or other equivalent electronic device to pay bills, pay other users, move funds from one registered users bank account or virtual bank account to another users bank account or virtual bank account, or to outside bank accounts.

A software module is defined as a series of process steps stored in an electronic memory of an electronic device and executed by the processor of an electronic device such as a computer, pad, smart phone, or other equivalent device known in the prior art.

A human key or human key module is defined as a collection of processor steps, within a computer server, and/or networked to other computer servers, that processes, facial and voice data, in a method where a person looking at the cam and talking or saying a phrase is identified, in a computer that work in real time to store and cross reference data for identification and security, as related to using an individual unique human being as a user name, password, or any other unique identifier of that unique human being, a Human Key can be attached to and/or substituted for QR code uses throughout the invention.

A quick view creator and viewer module is defined as a campaign and advertisement creation tool for making campaigns and advertisements that can be completely displayed, viewed and understood in a very short amount of time by the user. Utilizing an upload function that takes images, audio, text and assembles them together in a collage of a representation, and additionally where the text is converted to speech, for making it easy for a user to see and understand a campaign or advertisement in a short period of time.

A make an offer module is defined as a component where a user can create or make an offer for products, and/or services, on advertisements, campaigns, or embedded in QR codes revealed when scanned by device.

A search engine module is used for searching campaigns as related to advertisements, and QR code incentives, where a user can search for a product or service that they need, and can see what campaigns will benefit from the purchase, and at the same time what QR code offers are related, to the campaign and the advertisement, and what the QR Code pass along benefit will be if the user passes the QR Code off to their friends.

### SUMMARY OF THE INVENTION

The presented invention is a method for an advertising sponsor user, using a client computer, or mobile device to be able to register, login and create zip code related local sponsor advertisements, with small advertisements for creating interest in the offers, that link to bigger advertisements with an embedded shopping cart. When a user creates the advertisements, they can upload their images, and create their type for the offers in the same interface form and the advertisements are instantly created and able to be published immediately throughout a network.

Utilizing zip codes allows the system to use an intelligent smart decision engine, to make decisions of where advertisements and campaigns should be displayed as related to registered users locations for marketing and targeting. Also past performance and past advertisement information is utilized by the present invention to make appraisal value judgments as to the value of advertisements for sale, and campaign values for sale.

When a user creates campaigns a real bank account and a virtual bank account is created with credit card, debit card, coupon and/or voucher payments connected to the user account and a financial institution of their choosing, or designated financial institution by the system.

All transactions from the advertisements are associated with bar codes that are in the possession of the merchant business, which can be scanned at point of purchase. The accounting and discounts are automatically applied to the incentive management system in the main invention server location. By having advertisements linked to embedded shopping carts the users can purchase new or used items, products or services and can lock in coupons, offers and discounts for future uses and merchant location fulfillments.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 is a flow chart illustrating the method of advertising taught by the present invention;

FIG. 2 is a flow chart illustrating the registration process taught by the present invention;

FIG. 3 is a flow chart illustrating the fulfillment process taught by the present invention;

FIG. 4 is a flow chart illustrating the intelligent smart decision engine taught by the present invention;

FIG. 5 illustrates the statistics generated by the present invention;

FIGS. 6 and 7 illustrate the bid for advertisement placement method taught by the present invention;

FIG. 8 is a flow chart illustrating the a user advertising creator module of the present invention;

FIG. 9 is a flow chart illustrating the advertising creator function;

FIG. 10 is a flow chart illustrating the revenue process of the present invention;

FIG. 11 is a flow chart illustrating the automatic features of the present invention;

FIG. 12 is a flow chart illustrating the advertising and fee process of the present invention;

FIG. 13 is a flow chart illustrating the transaction process of the present invention;

FIG. 14 illustrates the bid for advertisement placement;

FIG. 15 is a flow chart illustrating the method for determining an incentive value;

FIG. 16 is a flow chart illustrating the campaign and associated advertiser functions;

FIG. 17 illustrates the payment module of the present invention;

FIG. 18 illustrates the advertisement creator module of the present invention;

FIG. 19 illustrates the advertisement creator module in more detail;

FIG. 20 illustrates an example advertisement and requirements; and

FIG. 21 illustrates the process of creating the advertisement or offer.

### DETAILED DESCRIPTION OF THE INVENTION

In the following detailed description, reference will be made to the accompanying drawings, in which identical functional elements are designated with like numerals. The aforementioned accompanying drawings show by way of illustration and not by way of limitation, specific embodiments and implementations consistent with principles of the present invention. These implementations are described in sufficient detail to enable those skilled in the art to practice the invention and it is to be understood that other implementations may be utilized and that structural changes and substitutions of various elements may be made without departing from the scope and spirit of present invention. The following detailed description is, therefore, not to be construed in a limited sense. Additionally, the various embodiments of the invention as described may be implemented in the form of software running on a general purpose computer, in the form of a specialized hardware, or combination of software and hardware.

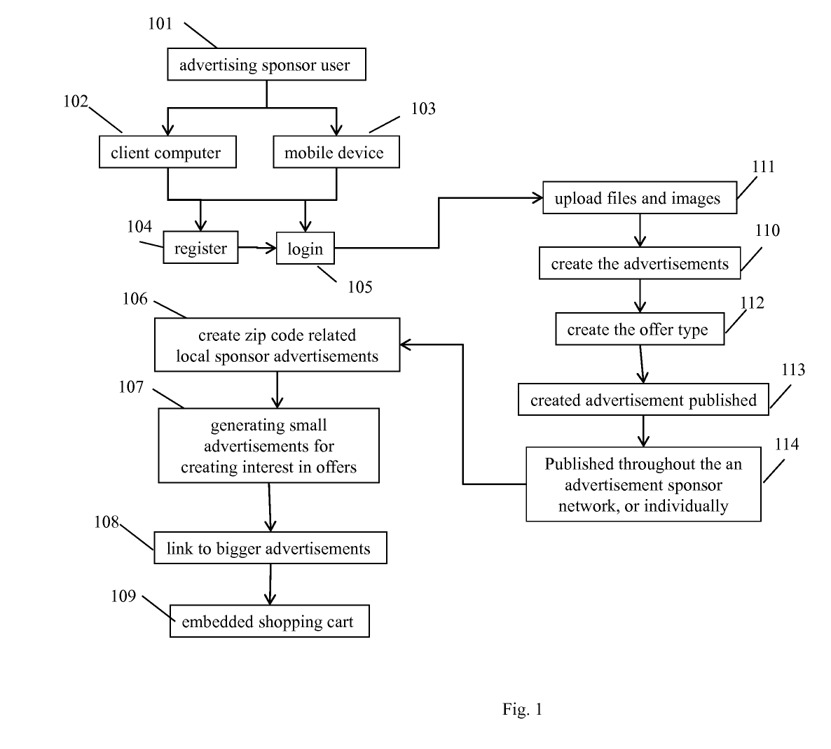

The current present invention is a method for an advertising sponsor user 101, using a client computer 102, or mobile device 103 to be able to register 104, login 105, and create zip code related local sponsor advertisements 106, with small advertisements for creating interest in offers 107, that link to bigger advertisements 108 with embedded shopping cart 109 as shown in FIG. 1. Another aspect of the invention is that when a user creates the advertisements 108, they can upload their images 110, and create their type for the offers 111 in the same interface form, and the advertisements 108 are instantly created and able to be published 112 immediately throughout the an advertisement sponsor network, or can be individually 113. By having advertisements linking to shopping carts embedded the users can purchase new or used items, products or services and can lock in coupons, offers and discounts for future uses and merchant location fulfillments.

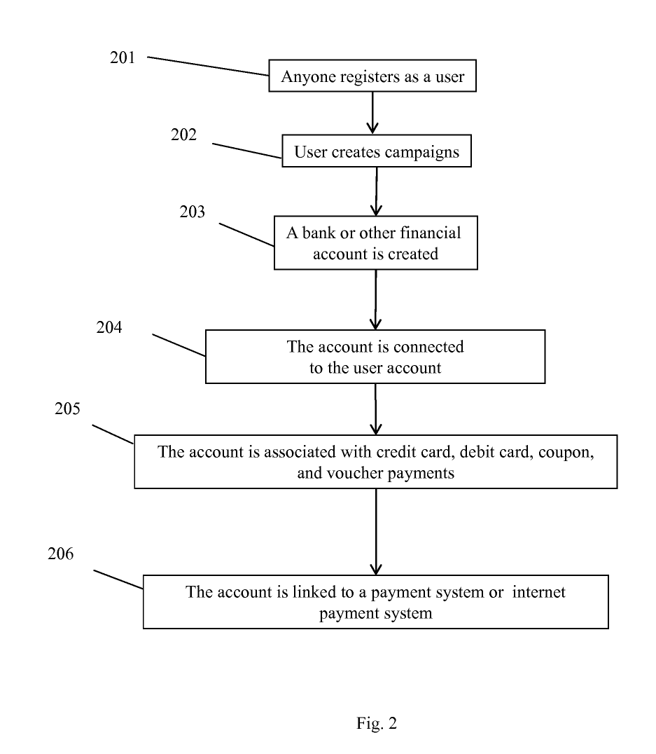

Another aspect of the method, as shown in FIG. 2, involves where when anyone registers as a user 201 and creates campaigns 202 a bank or other financial account is created 203 and associated with the registered user 201. The bank or financial account 203 is associated with credit card, debit card, coupon, and voucher payments 204 and connected to the user account 205 and linked to a payment system or internet payment system 206.

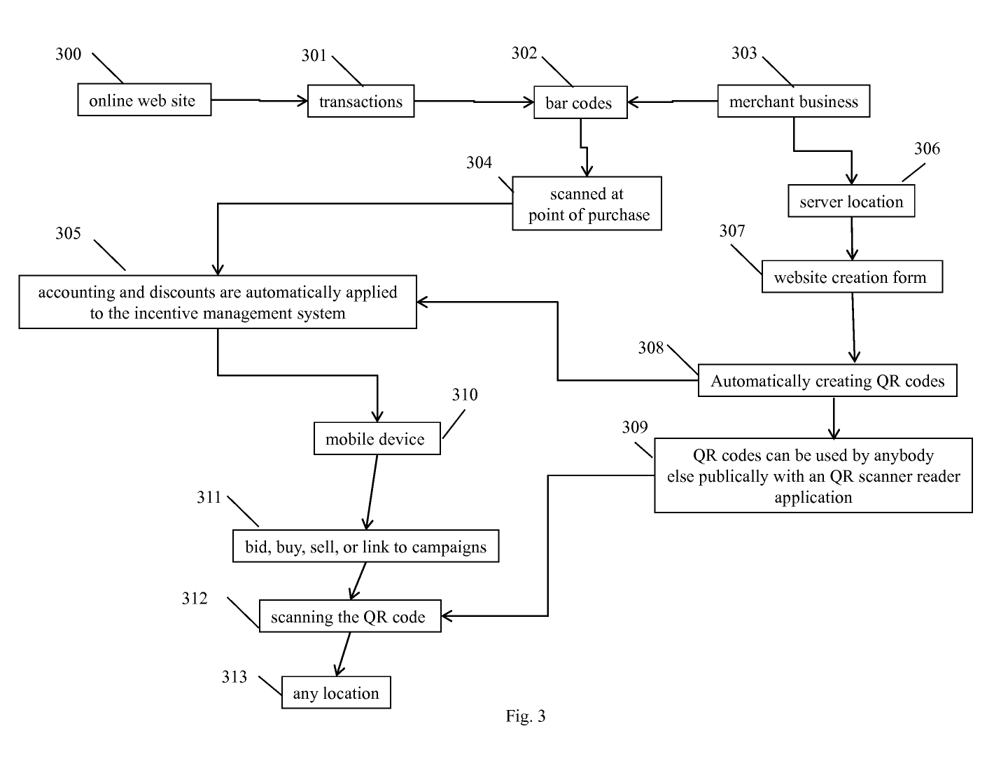

Now referring to FIG. 3, another aspect of the present invention is related to the fulfillment of incentives and offers, as related to businesses and conversions through an online web site 300. The present invention handles these transactions 301 with bar codes 302 that are in the possession of the merchant business 303 that can be scanned at point of purchase 304 and the accounting and discounts are automatically applied to the incentive management system 305 in the main invention server location 306. A website creation form 307 is provided for automatically creating QR codes 308 for each registered user 309. QR codes 308 can be used by anybody else publically with an QR scanner reader application 309 installed on their mobile device 310, to bid, buy, sell, or link to campaigns 311, by just scanning 312 the QR code 308 at any location 313.

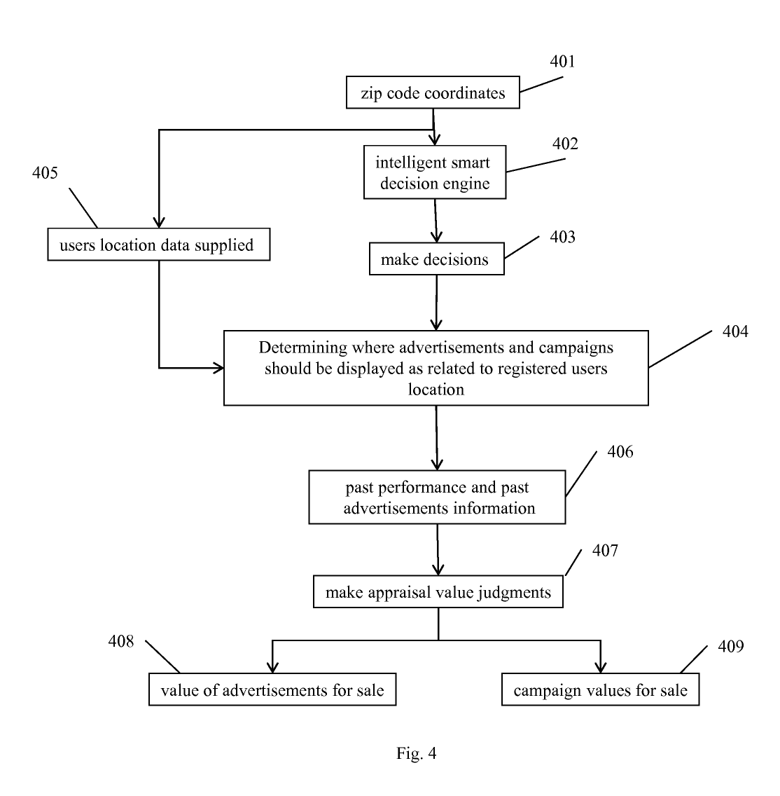

Now referring to FIG. 4, by utilizing zip code coordinates 401 the method can use an intelligent smart decision engine 402, to make decisions 403 of where advertisements and campaigns 404 should be displayed as related to registered users location data supplied 405. Also past performance and past advertisements information 406 is utilized by the invention process to make appraisal value judgments 407 as to the value of advertisements for sale 408 and campaign values for sale 409.

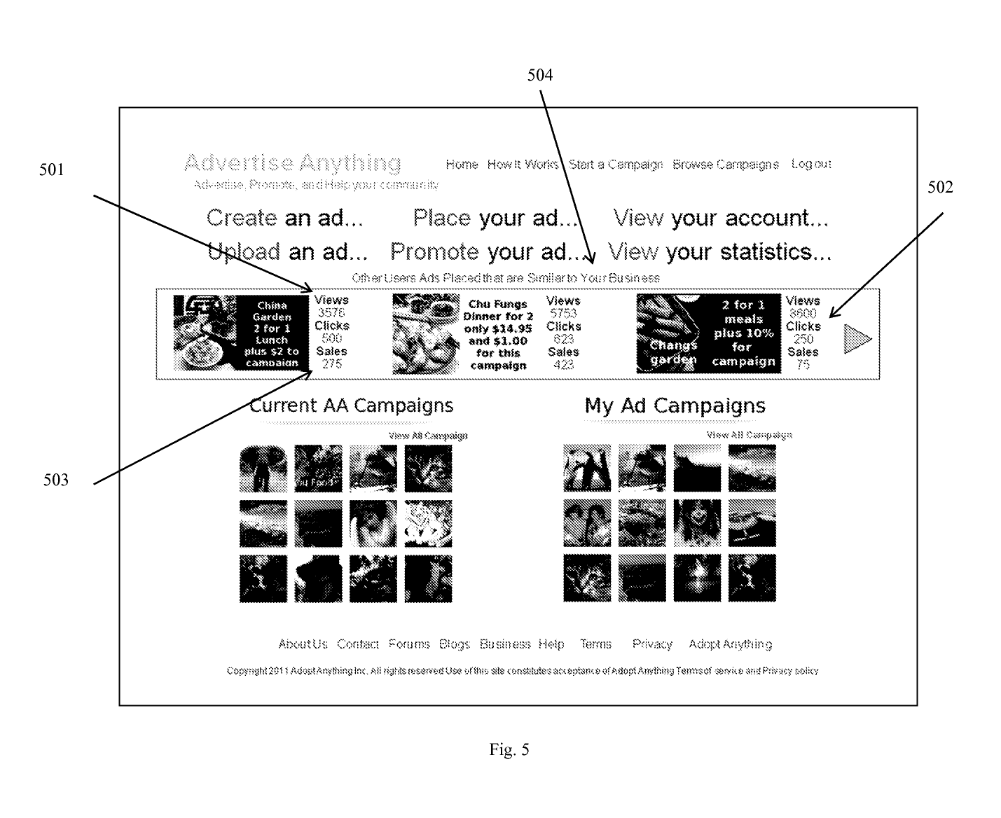

Statistics such as how many views 501, click through fulfillment 502, and actual purchasers 503 are also aggregated in the method to allow users to be able to make better decisions, and campaigns to benefit from transactions generated from advertisements in the system. As shown in FIG. 5, these statistics illustrate similarities such as “other user ads placed that are similar to your business” 504.

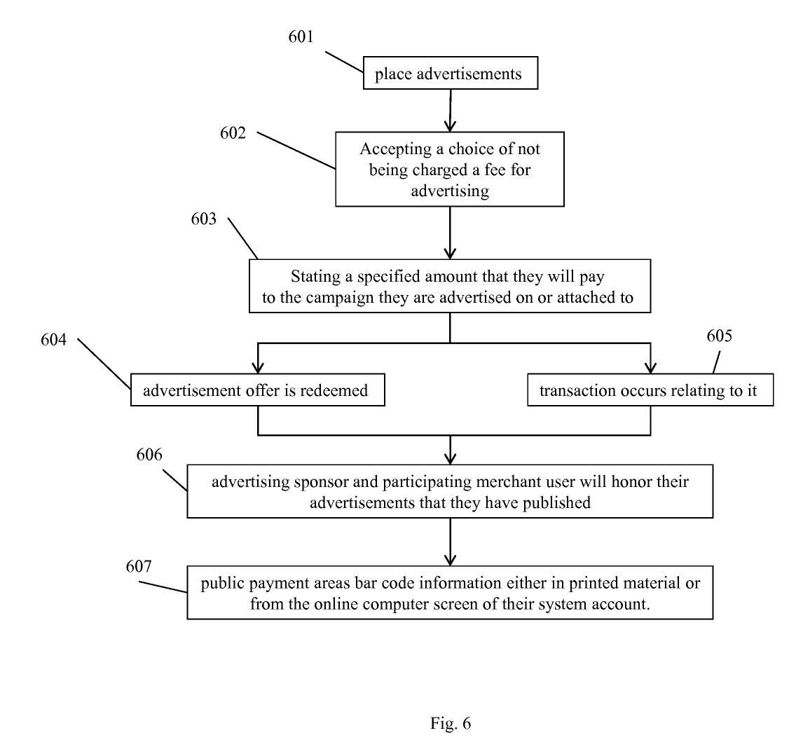

Now referring to FIG. 6, another aspect of the invention is that users that place advertisements throughout the method 601, are offered a choice of not being charged a fee for advertising 602, but are required to state a specified amount 603 as little as 25 cents that they will pay to the campaign they are advertised on or attached to, if their advertisement offer is redeemed 604 or a transaction occurs relating to it 605 and that the advertising sponsor and participating merchant user 606 will honor their advertisements that they have published and present at public payment areas bar code information either in printed material or from the online computer screen of their system account 607.

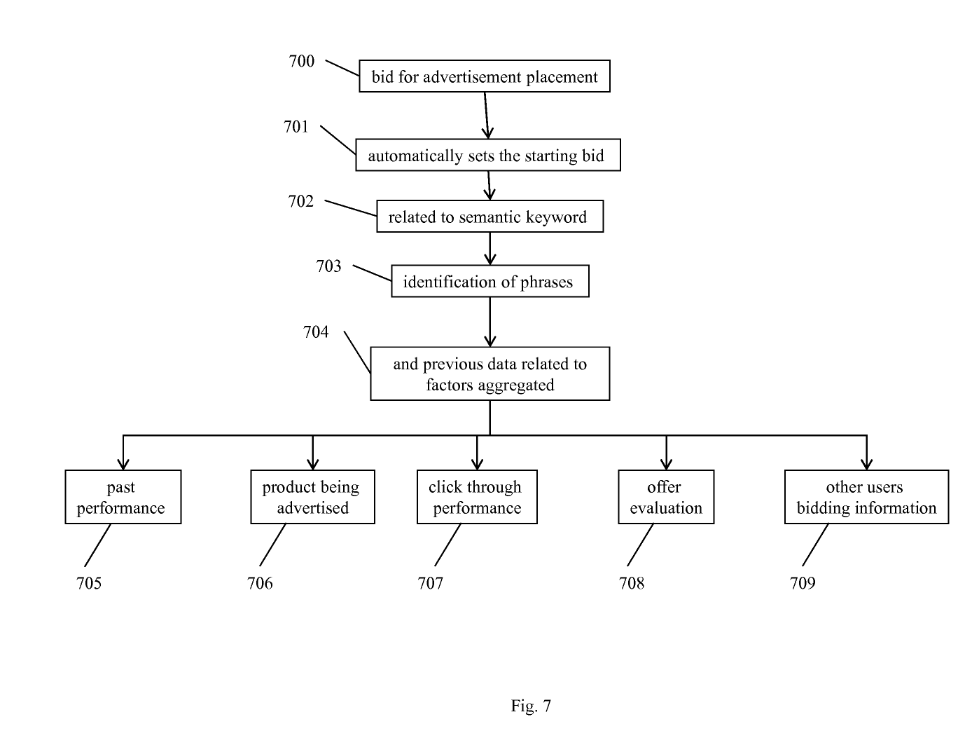

Another aspect of the invention is the bid for advertisement placement 700 in the advertisement network as shown in FIG. 7, that automatically sets the starting bid 701 as related to semantic keyword 702, identification of phrases 703, and previous data related to factors aggregated 704 such as, past performance 705, product being advertised 706, click through performance 707, offer evaluation 708, and other users bidding information 709.

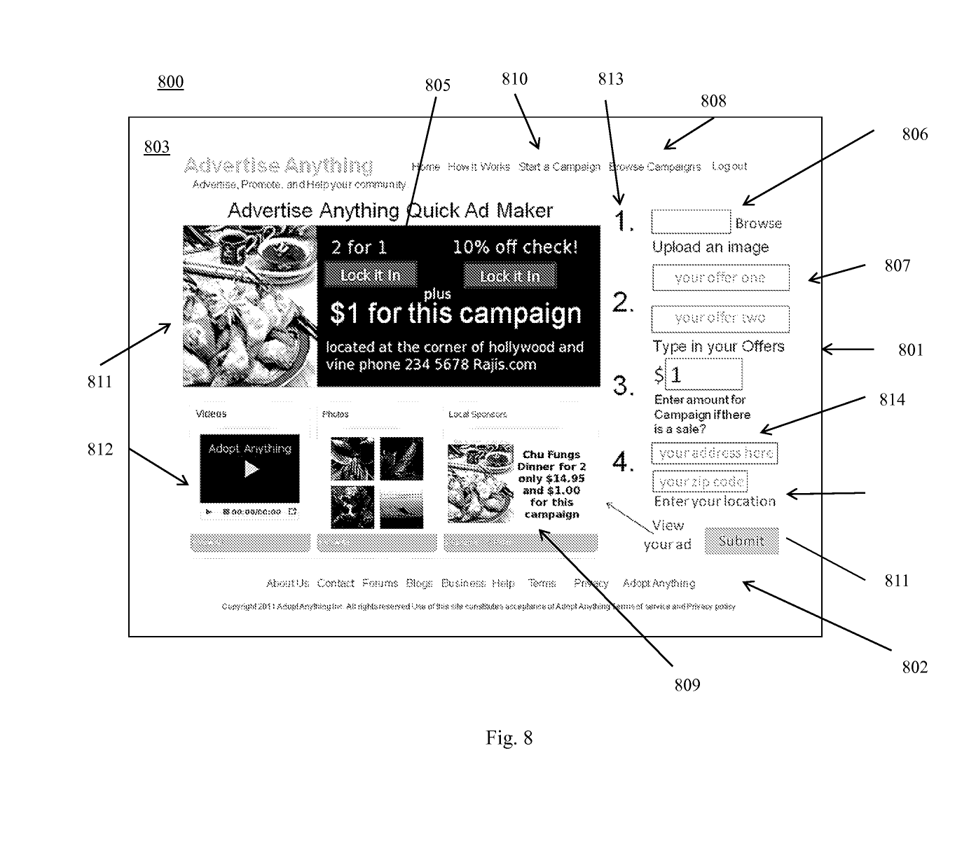

The present invention teaches a user advertising creator module as shown in FIG. 8. An automated machine advertising creator system 800 is comprised of an administration advertising creator system 801 that is embedded into a campaign system 802, or can be run independently on websites 803 or in mobile or static applications 804 that allows uploads 813 with protected intellectual property registration utilizing attachment and encoding intellectual property to the Human Key, and/or a QR code, as a reference for tracking and identification 814. There are multiple functions for taking orders 805, uploading advertisement images 806, adding text advertisements and information 807, tracking views and clicks through to offers 808, and links on a website 809, enabling advertisements to be connected to users' campaigns 810, and that sales or transactions from advertisements, must benefit a designated campaign 811 or plurality of campaigns 812.

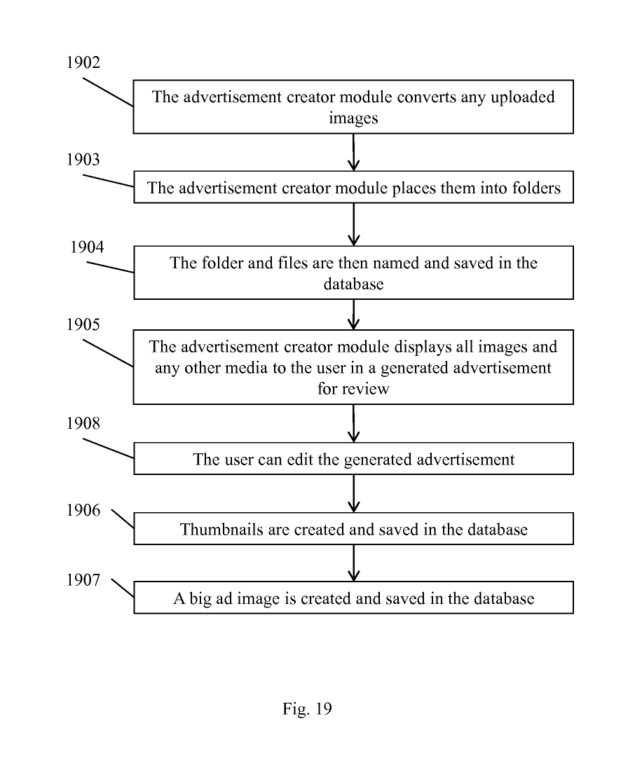

Now referring to FIG. 19, the advertisement creator module is illustrated in more detail.

The advertisement creation module present the user with a display form 1901 for browsing their location machine or linking to website for uploading of images, video, or other media. The advertisement creator module then converts any uploaded images 1902 and places them into folders 1903, the folder and files are then named and saved in the database 1904. Next the advertisement creator module displays all images and any other media to the user in a generated advertisement for review 1905. The user can edit the generated advertisement. Once the generated advertisement is saved thumbnails 1906 are created and saved in the database 1904 in addition to a big ad image 1907 being created and saved in the database 1904.

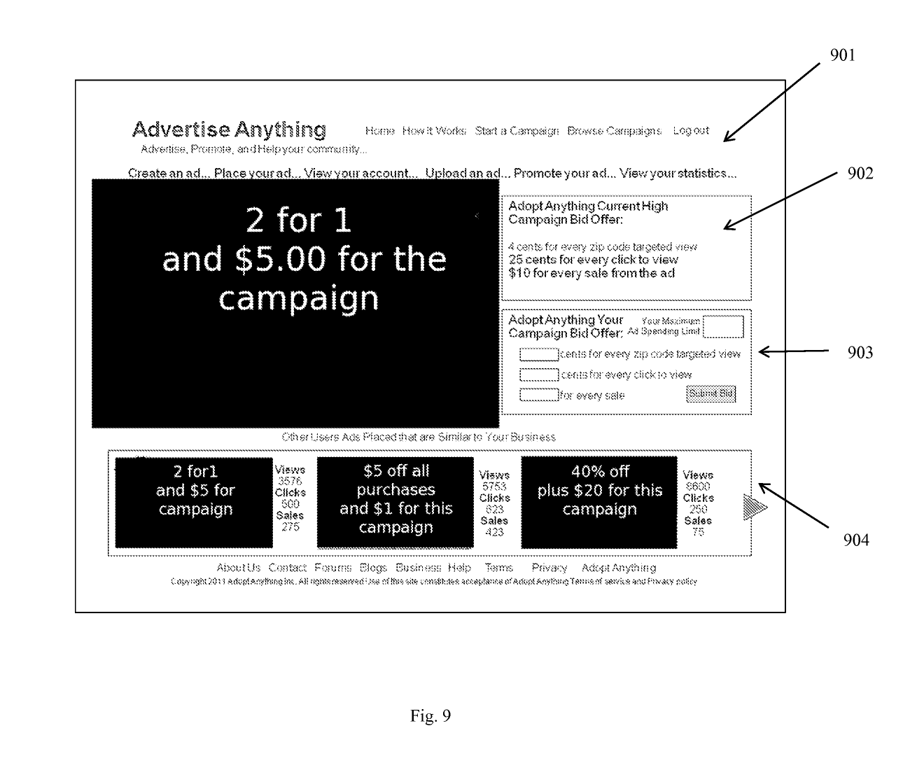

Users can have combinations of user advertisements rotated in a composite formation area 901, and these combinations of users advertisements 902 can be searched in a cluster of advertisements with relationships to the primary subject of the advertisements 903, with similarity of interested searches combined with request and smart relationship functions for products, services, and information 904, and an advertising creator function connected to the advertising placement system, connects campaign donations for the purpose of creating revenue, and interest in campaign related subjects, including shared percentages, and defined amounts of money and discounts with campaign users, creators, and beneficiaries as shown in FIG. 9.

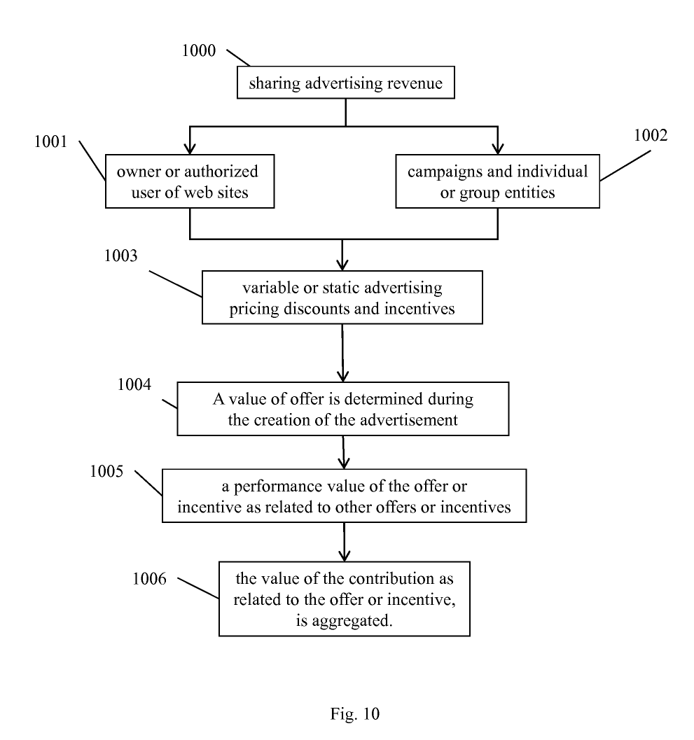

Now referring to FIG. 10, the method teaches sharing advertising revenue 1000 with the owner or authorized user of web sites 1001, campaigns and individual or group entities 1002, with variable or static advertising pricing discounts and incentives 1003. A value of offer is determined during the creation of the advertisement 1004, with a performance value of the offer or incentive as related to other offers or incentives 1005, also the value of the contribution as related to the offer or incentive, is aggregated 1006. Advertisements are free, but the offer has to be included in the advertisement, and the contribution offer additionally has to be included either in print, video, image, or audio in the advertisement. All incentives are evaluated, classified, and stored for later reference, and attached, tracked, and solicited to donation, personal, or informational campaigns. An additional feature of the method is that bank accounts, credit cards, printed coupons vouchers and debit cards accounts are created at the time of registration, advertising and campaign creation as previously discussed, with debit and credit cards incentives attached to cash discounts at the point of purchase or point of sale.

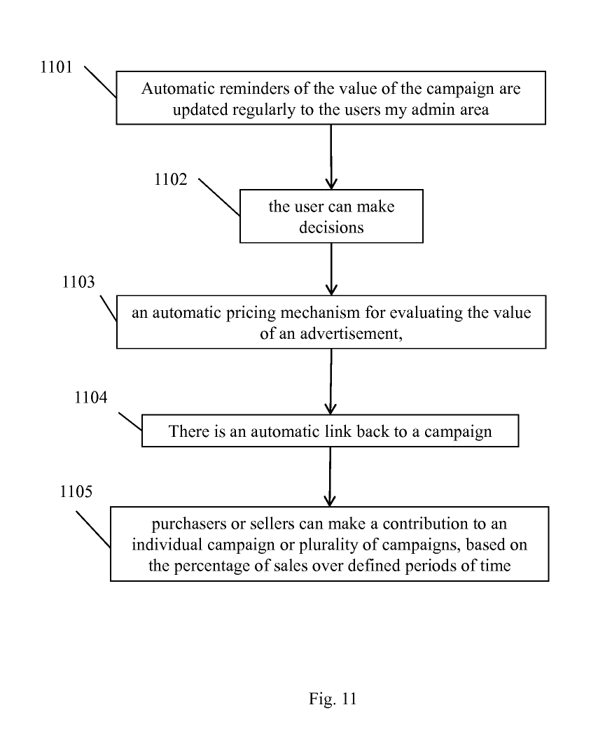

The method provides for matching contributions combined with advertisement and donations, with automatic pricing for evaluating the value of a campaign, for resale if the user chooses as shown in FIG. 11. Automatic reminders of the value of the campaign are updated regularly to the users my admin area 1101, so the user can make decisions 1102, as well there is an automatic pricing for evaluating the value of an advertisement, for resale, with the same updates reminders as the campaigns system 1103. There is an automatic link 1104 back to a campaign where any single or plurality of vendors, purchasers or sellers can make a contribution to an individual campaign or plurality of campaigns 1105, based on the percentage of sales over defined periods of time, and users can vote on where or which campaign they want proceeds to go to the method also includes a search engine for searching, and display of advertisement offers as related to donations, services, businesses, personal and campaigns utilizing, automated semantic keyword sorting and related subjects.

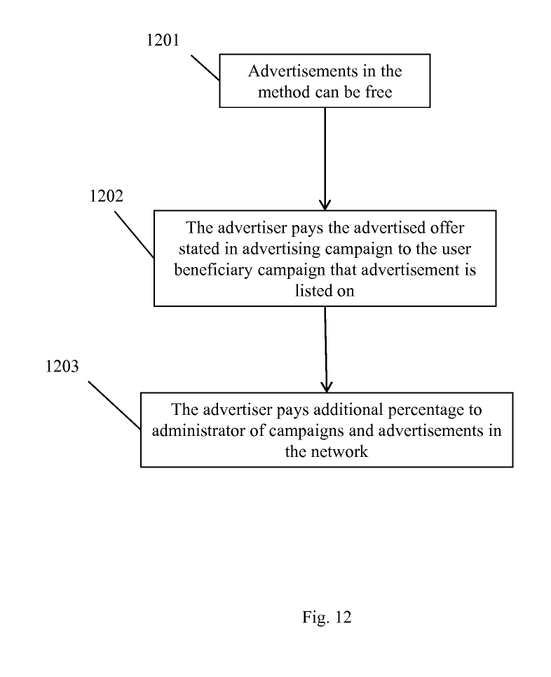

The method further provides the use of campaigns for promotion, funding, listing, and fulfillment of intellectual property concepts and business concepts, and includes an advertising creator discount campaign donation function for the purpose of attaching advertising beneficiary donations to sales from an advertising offer, as shown in FIG. 12. Advertisements in the method can be free 1201, but the advertiser pays the advertised offer stated in advertising campaign to the user beneficiary campaign that advertisement is listed on 1202, and pays additional percentage to administrator of campaigns and advertisements in the network 1203.

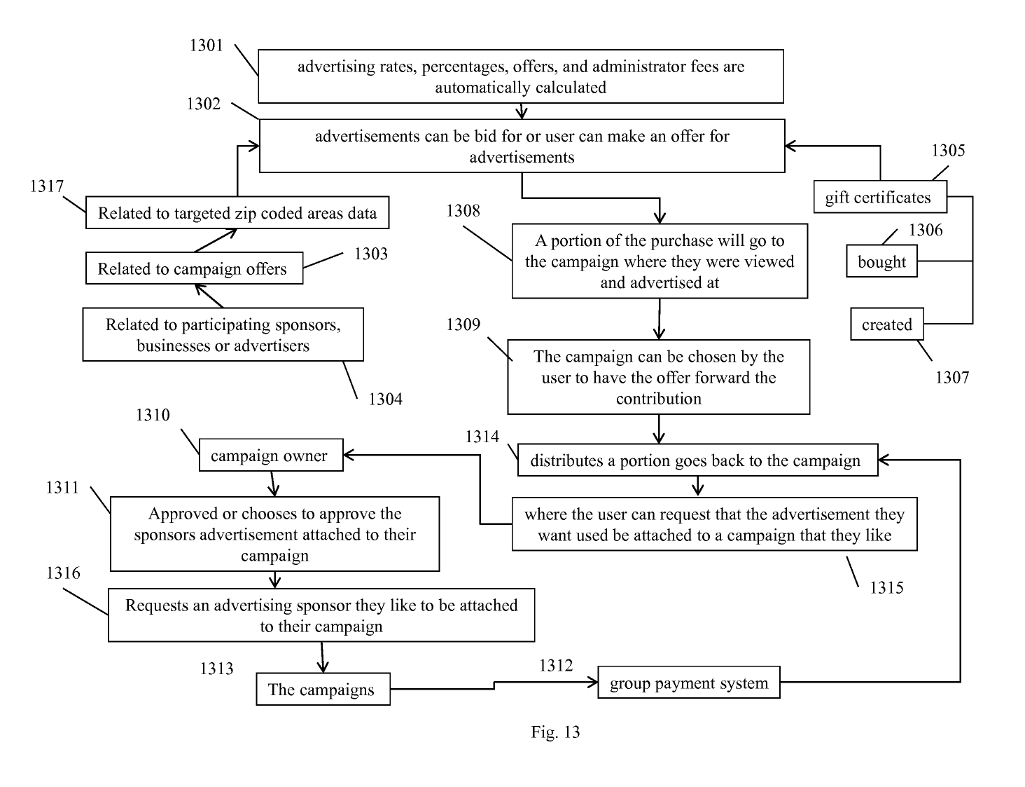

Now referring to FIG. 13, advertising rates, percentages, offers, and administrator fees are automatically calculated 1301, and advertisements can be bid for or user can make an offer for advertisement 1302 related to targeted zip coded areas data 1317, as related to campaign offers 1303, and also participating sponsors, businesses or advertisers 1304. Another aspect of the invention provides gift certificates 1305 that can be bought 1306 and created 1307 and a portion of the purchase will go to the campaign where they were viewed and advertised at 1308, or the campaign can be chosen by the user to have the offer forward the contribution through 1309. If the campaign owner 1310 has approved or chooses to approve the sponsors advertisement attached to their campaign 1311, a group payment system 1312 attached to the campaigns 1313, distributes a portion goes back to the campaign 1314 where the user can request that the advertisement they want used, be attached to a campaign that they like 1315, or a campaign owner can request an advertising sponsor they like to be attached to their campaign 1316.

A campaign beneficiary may receive a service, product, or cash incentive, if an advertiser or sponsor receives a purchase or sale. The advertisements used in the method presented here includes at least an offer, such as a campaign promotion, discount, incentive, reward, coupon, gift, cash back, benefit, product, or service. The present invention further provides a system that identifies, and influences a shopper's decision to purchase products based upon data aggregated related to the relationship of a user's, or shopper's campaign, with the shopper's products, services or informational needs and subject to the shopper's liking of the subject, story, images, video, files or sponsors, advertisements of the campaign, and further analysis in the presented method and system is based on transaction data associated with a plurality of users in the method.

The method further includes quantifying the relative value of a campaign for the purpose of reselling the campaign, and includes quantifying the relative value of an advertising campaign for the purpose of reselling the advertisement, and includes quantifying the relative value of collaborative works, for the purpose of reselling the collaborative work, and quantifying the relative value of a user account in a network for the purpose of reselling the user account and can be a protected or unprotected intellectual property that can be bought, sold, bartered, and bid on.

All functions can be used in mobile devices, mobile applications, aircraft displays, used in gaming platforms, and can be used in at least one ATM or standalone kiosk or a plurality of

ATM's or kiosks where the incentive can be a ticket, voucher, coupon or prepaid debit card dispensed from an ATM or kiosk with a receipt of a transaction, included with an advertising offer, and where a campaign, offer, and advertising incentives can be displayed on a screen of an ATM or kiosk and can be scanned by a mobile device, with the application installed, or another application with presented system installed to grab the incentive. A mobile tablet pc, computer, and handheld device can run an application that makes it a ATM and kiosk with search connected back to campaigns, and for making deposits, purchases and payments, and also includes where the offers, campaigns, and advertisements can be accessed through another network utilizing a scan able, bar code, or numbered redeemable code.

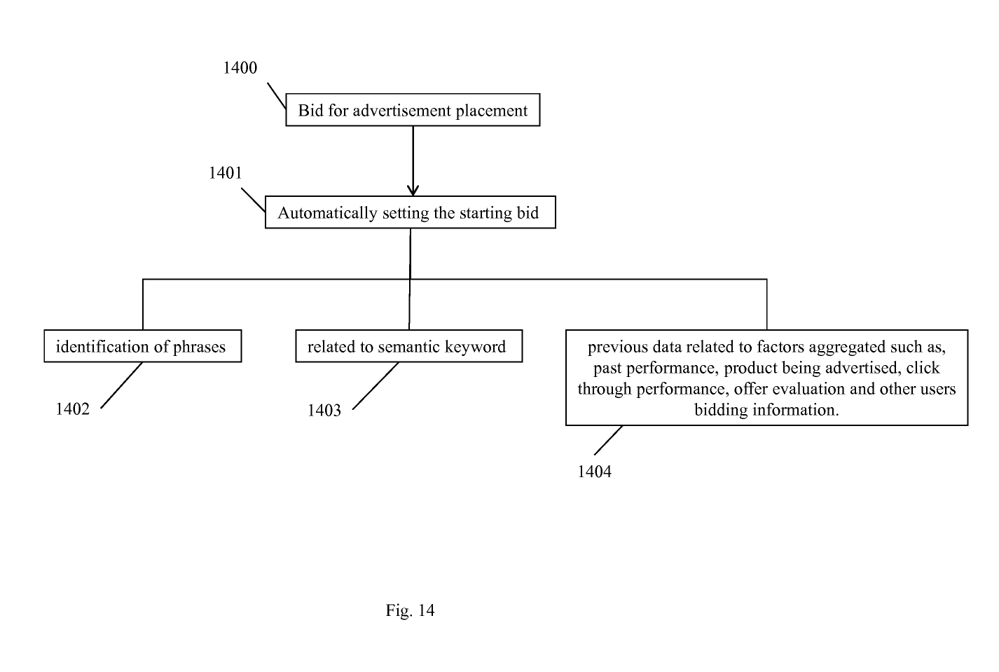

Another aspect of the invention is the bid for advertisement placement 1400 in the advertisement network as shown in FIG. 14. The bid for advertisement placement 1400 automatically sets the starting bid 1401, as related to semantic keyword 1402, identification of phrases 1403, and previous data related to factors 1404 aggregated such as, past performance, product being advertised, click through performance, offer evaluation and other users bidding information.

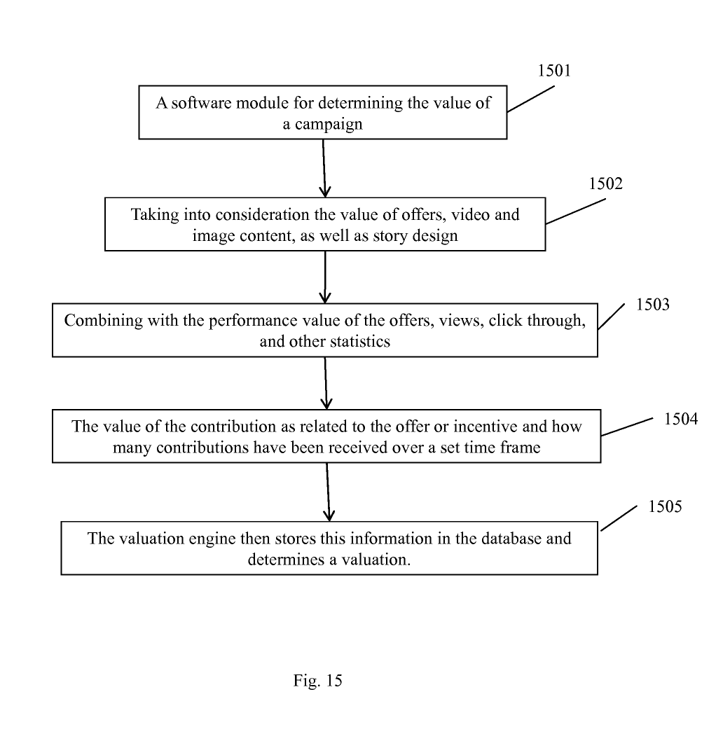

Now referring to FIG. 15, the method for determining an incentive value is described. In a first step 1501 a software module for determining the value of a campaign first takes into consideration the value of offers, video and image content, as well as story design 1502. This is then combined with the performance value of the offers, views, click through, and other statistics 1503 and the value of the contribution as related to the offer or incentive and how many contributions have been received over a set time frame 1504. The valuation engine then stores this information in the database 1505 and determines a valuation.

The method of the present invention can also be integrated into a virtual world running on a computer system. A software module is provided for creating virtual vouchers, coupon, rebates, and other discounted transactions with virtual currency. Virtual currency can be given, as a further incentive to promote transactions, and encourage users to spend time in the system, or perform tasks that are beneficial to systems owners, such as clicking on advertisements, making purchases sales and transactions, and using virtual cash and virtual gold, as a reward for uploading content, rating owners of campaigns, and advertisers products and services. Virtual currency can be either virtual cash, virtual credit, or virtual gold.

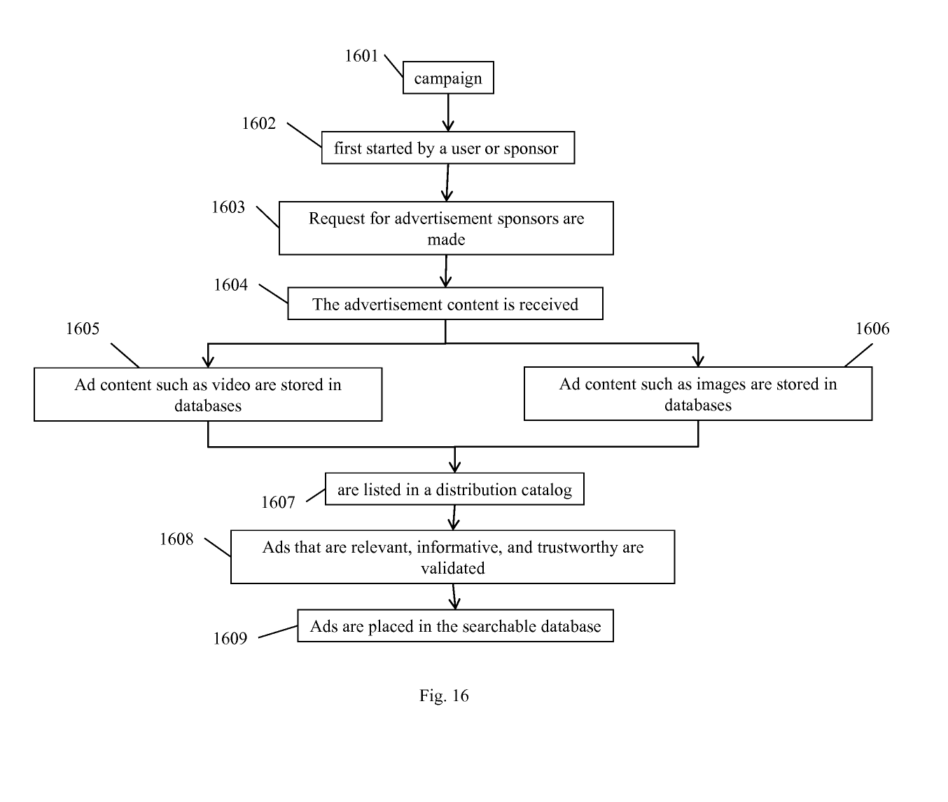

Now referring to FIG. 16 a campaign and associated advertiser functions are shown. The campaign 1601 is first started by a user or sponsor 1602. Request for advertisement sponsors are made 1603 and the advertisement content is received 1604. Ad content such as video and images are stored in databases 1605 and 1606 and are listed in a distribution catalog 1607. Ads that are relevant, informative, and trustworthy are validated 1608 and placed in the searchable database 1609.

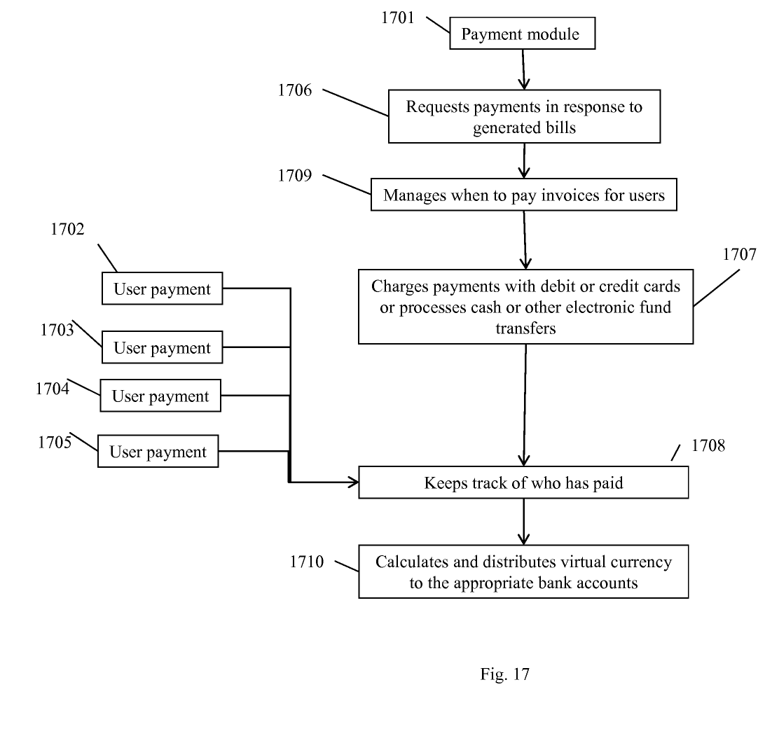

A payment module 1701, as shown in FIG. 17 the payment module 1701 then requests payments in response to generated bills 1706 and receives payments from one or more users 1702-1705. The payment module 1701 charges payments with debit or credit cards or processes cash or other electronic fund transfers 1707. The payment module 1701 keeps track of who has paid 1708 and manages when to pay invoice for users 1709 as well as calculating and distributing virtual currency to the appropriate bank accounts 1710.

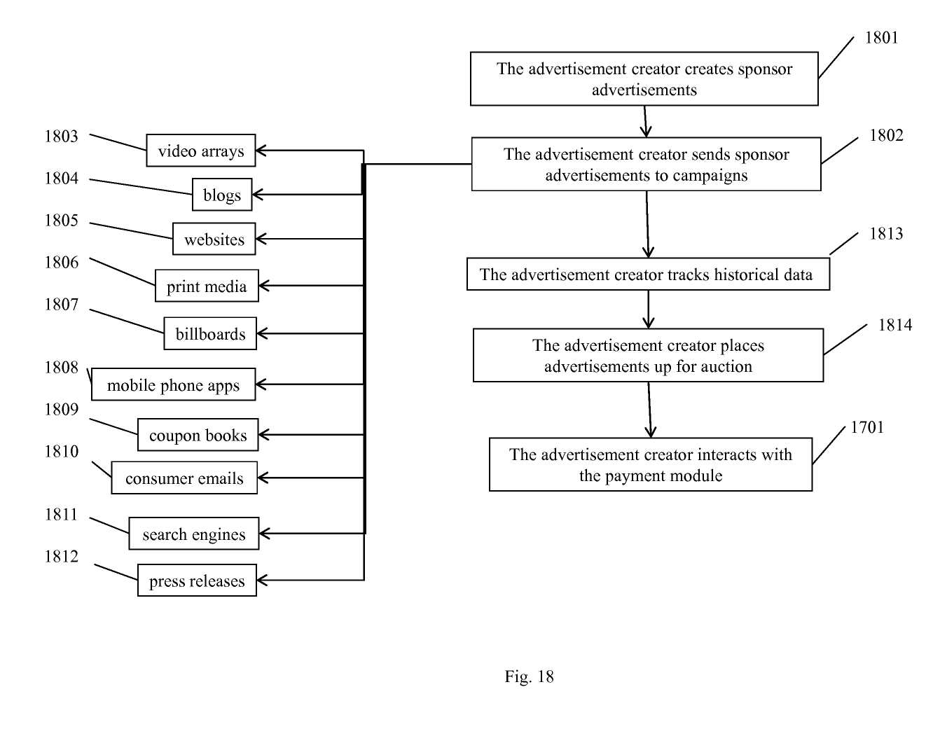

Now referring to FIG. 18, one embodiment of the advertisement creator module is shown. In this embodiment, the advertisement creator creates sponsor advertisements 1801 and sends them to campaigns 1802, video arrays 1803, blogs 1804, websites 1805, print media 1806, billboards 1807, mobile phone apps 1808, coupon books, 1809, consumer emails 1810, search engines 1811, and press releases 1812. The advertisement creator module 1801 can also track historical data 1813, places advertisements up for auction 1814, and interact with the payment module 1701.

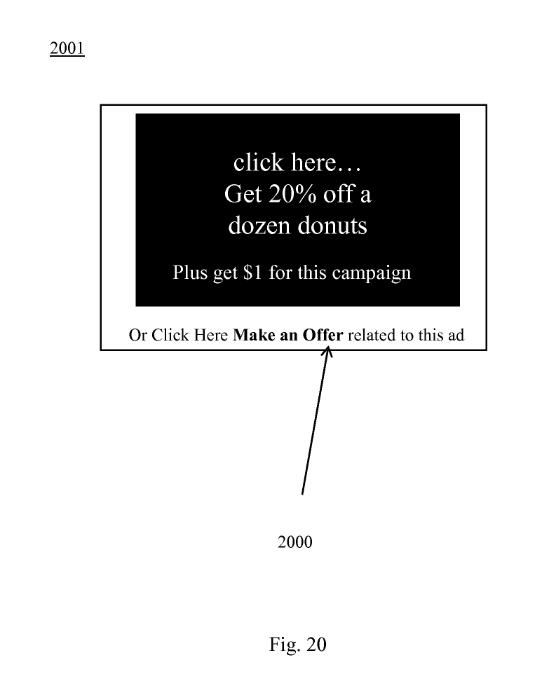

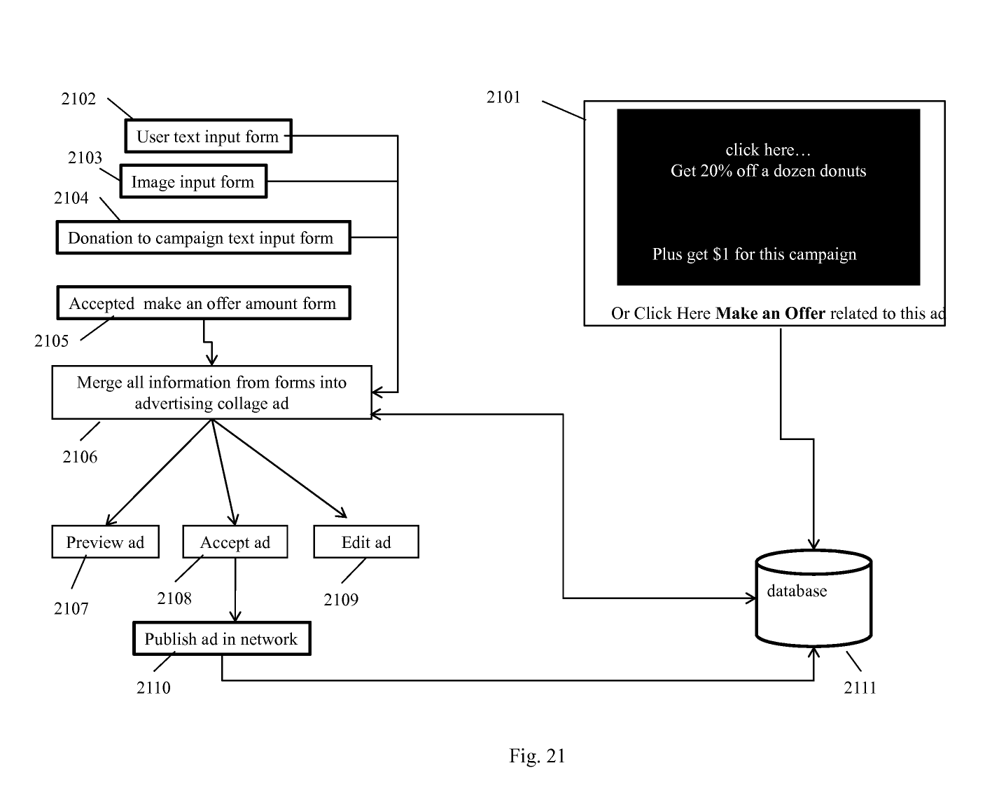

FIGS. 20-21 illustrate an example of the method and process for registration, creation and management of campaigns and advertisements in a network system. In this example one or more people are trying to raise money for a party. As shown in FIG. 20, the person establishing the campaign first uses the make an office module method 2000 to create an advertisement 2001 that offers a coupon that when redeemed generates revenue for the campaign. In this example, a person using the coupon would receive 20% off a dozen donuts and through that use generate $1 toward the campaign goal. The advertisement contains text related to the amount being donated as well as the offer.

FIG. 21 illustrates the process of creating the advertisement or offer 2101. A user first inputs text 2102, images 2103, donation parameters 2104, and offer parameters 2105 where are then merged 2106 to generate a preview ad 2107 which can then be accepted 2108 or edited 2109. Upon acceptance the ad is published in the network 2110 and stored in a database 2111.

Moreover, other implementations of the invention will be apparent to those skilled in the art from consideration of the specification and practice of the invention disclosed herein. Various aspects and components of the described embodiments may be used singly or in any combination in the computerized content filtering system. It is intended that the specification and examples be considered as exemplary only, with a true scope and spirit of the invention being indicated by the following claims.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The embodiments of the invention in which an exclusive property or privilege is claimed are defined as follows:

1. A method for executing a series of instructions on a computer system, the method comprising:
registering a user account in a computer system;
aggregated data, and media;
generating one or more QR codes attached to the registered users account;
generating one or more bar codes attached to the registered users account;
generating graphical representations of users or users entities attached to the registered users account;
creating and attaching human keys to the registered users account;
creating and attaching bank accounts to the registered users account;
creating and attaching additional registrations to one or more websites to the registered users account;
creating and attaching opted in registration into a registry to the registered users account;
creating and attaching advertising management and creation accounts to the registered users account;
creating and storing campaigns in a database;
creating one or more campaign accounts by a user;
uploading and storing images related to campaigns, advertisements and media, for user viewing and that can be read by an optical scanner to determine ownership, information, offers, and valuations;
uploading and storing images that can be read by an optical scanner for information after a registration process;
receiving donations, contributions, or funds deposited into a campaign account;
allowing a user to manage the created campaign;
raising a target designated specified amount;
allowing the user, up to a designated specified amount, to use a defined amount from the campaign bank account for additional promotions and services for their campaign from inside or outside designated vendors approved by the method administrators;
issuing and providing a single or plurality instance of credit cards, debit cards, coupons, and vouchers for the purpose of enabling the user to make transactions;
providing an advertising management for;
taking customer orders from links in customer's advertisements;
uploading advertisement images;
uploading advertisement videos;
uploading text and information to the advertisement creator system;
enabling protection of intellectual property that is uploaded;
tracking views and clicks from offers and incentives within advertisements;
enabling advertisements to be placed on campaigns;
offering free advertisement placements when a user states in the advertisement clearly a stated offer displayed on the advertisement;
defining the portion that will go to the campaign if and when there is a redemption of the advertiser offer in the advertisement;
attaching a group payment system to a campaign;
distributing a portion goes back to the campaign;
connecting one or more QR code bars for tracking and reporting redemptions of fulfilled advertisement purchases and portions of the sales earned;
depositing earned portions directly to the campaign bank account;
offering paid advertisement placements;
aggregating and placing advertisements with a relationship to zip code, postal codes, spatial point information, for international and national location based advertising fulfillment and use;
enabling static and variable incentives in advertisements related to the ability of the advertiser to change incentives at any time in the advertisement;
enabling an automated machine advertisement creator;
automatically creating advertisements where a preset valued advertiser incentive is related to a preset campaign fulfillment contribution, for the purpose of creating bulk quantities of advertisements, by an advertiser;
providing an independent application that can be used in a mobile phone, computer, and website for the purpose of managing advertising, and campaign services;
creating and uploading a plurality of advertisements owned by one or more users to be published in one advertisement space at the same time;
providing a valuation for the actual offer in an advertisement aggregated from the information obtained during the creation of the advertisement in the method, and further continually tracking the performance of the advertisement for additional valuation purposes;
creating credit cards, debit cards, on-line and printed coupons, and vouchers at the time of the creation of the advertisement;
providing for debit and credit cards to be attached to cash discounts, whereby when a credit card or debit card is used the discount is automatically applied to the transaction;
creating matching contributions by other users combined with advertisements incentives and campaign donations;
calculating, and displaying or suggesting advertising rates, percentages, offers and administrator fees, at the time of advertising creation;
bidding for advertisement placement as related to targeted zip code or postal code information, the type of campaign, the advertising offer, the participating sponsors and the advertisers;
providing gift certificates for individual or a plurality of individuals;
linking one or more cards, one or more written or printed offers advertisements that can be uploaded or created to the gift certificates where a specified portion of the purchase of the advertised gift certificates will go to the campaign where the gift certificate advertisement was advertised on, at the time of fulfillment and purchase;
selecting an advertisements to go into a shopping cart to make an immediate purchase;
locking in an offer displayed in the advertisement selected;
providing a campaign management and creator for;
providing discounts and searching for discounts on other campaigns within networks and outside networks;
appraising a campaign or advertisement, for the purpose of valuation, bartering or selling the campaign or advertisement;
tagging or linking traffic, advertisements, or resources from, one campaign to another campaign;
creating a campaign that can be created for the purpose of raising funds that will be used as an investment in another campaign;
creating a campaign that can be created for the purpose to promote, aggregate, collect funds, invest, and loan, into another campaign or campaign bank account;
aggregating and managing a search engine for users to be able to search relationships between campaigns, advertiser incentives in advertisements, and contributions in advertisements for each campaign;
enabling a campaign beneficiaries to receive a single or plurality of services, products, or cash incentives if an advertiser gets a completed sale of a products, services, tangible or intangible objects;
providing a bulk up loader application function and method for creating a plurality of totally different campaigns and submitting them at one time in the system;
enabling and requiring advertisements used in the campaigns or outside campaigns in the method and system to include at least one or a plurality of offers, such as a campaign promotion, discount, incentive, reward, coupon, gift, cash back, benefit, product, or service incentives;
quantifying the relative value of a campaign or outside campaign for the purpose of reselling the campaign;
quantifying the relative value of an advertising campaign for the purpose of reselling the advertisement;
quantifying the relative value of a user for the purpose of reselling the user account;
quantifying the relative value of a website for the purpose of reselling the website;
disseminating the advertisement to a video, audio, catalog, grid placement system, print media, television, radio, mobile phone, network, or computer, kiosk.
transforming a website into one or more campaign pages by;
providing the inputting of a URL location of a website into a form;
extracting all data, media and images from the URL location of the website;
storing all extracted data as a file in a folder;
storing all extracted text as data in a database on a server;
obtaining domain owner administrator information;
storing the domain owner administrator information as a file in the folder in the database;
processing the data to make the data viewable on a web page;
sending URL, website, text, or image information to the form for input;
providing options to choose a language translator for campaign translation, to publish, make public or private, or print the campaign;
creating a website search software application module either from tables on the server or by the entry of a search item;
inputting a URL location of a website into a search form;
extracting all data, media and images from the URL location of the website; storing all extracted data as a file in a folder and text as data in a database on a server;
obtaining domain owner administrator information;
storing the domain owner administrator information as a file in the folder in the database;
processing the data to make the data viewable on a web page;
sending URL, website, text, or image information to the form for input;
providing options to choose a language translator for campaign translation, to publish, make public or private, or print the campaign;
submit data to external websites, search engines, and designated forms; and
providing editing and deletion of the website created page, created media, created files, and website search software application.

2. The method of claim 1, used in mobile devices and mobile applications for tracking and placing advertisements and campaigns; and further providing creating a website campaign with the aggregated data and media.

3. The method of claim 1, used in aircraft displays, and vehicles for rapid deployment information processing and value decisions in real time; providing creating an advertisement with the aggregated data, and media.

4. The method of claim 1, used in gaming platforms for enhancing the gaming experience;
providing creating a video with the aggregated data and media.

5. The method of claim 1, used in one or more ATM or Kiosk; providing creating a one or more images with the aggregated data and media.

6. The method of claim 1, wherein the incentive is a ticket or prepaid debit card dispensed from an ATM or Kiosk with a receipt of a transaction included with an advertising offer or scanned code for link backs to campaigns; creating one or more catalogs for browsing or shopping, with the aggregated data, and media.

7. The method of claim 1, wherein campaign, offer, and advertising incentives are displayed on a screen of an ATM or Kiosk and can be scanned by a mobile device to grab the incentive and lock in the price, value, or incentive offered; creating a virtual world or a virtual world place with the aggregated data, and media.

8. The method of claim 1, wherein the offers, campaigns, and advertisements can be accessed through another network utilizing a scan-able bar code, QR code, any scan able virtual representation of an object, organic or inorganic, or numbered redeemable code; creating a new website with the aggregated data, and media.

9. The method of claim, 1 wherein a user can sign up for free advertising if the user puts an affiliate advertisement for free on a website;
creating, by a code, one or more affiliate software application search modules on the server;
copying the code of the affiliate software search application module from the server;
pasting the code of the affiliate software search application module into a website;
displaying the affiliate software application search module on a website; and
generating a commission when a sale occurs through the affiliate software search application module.

10. The method of claim 1, wherein the user can bid for placement throughout the network and outside the network; creating an auction or sales website with the aggregated data, and media.

11. The method of claim 1, wherein advertisements can click through to catalogs and split products offers; providing editing advertisements or campaigns images, media and text data, utilizing the aggregated data, and media.

12. The method of claim 1, wherein campaigns and incentives can have split funded contributions, loans and investments;
determining semantically where loans are and where to put money;
arranging investment loan pools;
generating valuations of loan rates and investment rates;
selecting between split funding and conventional funding;
electing beneficiaries of the funding; and
transforming a website, based on the submitted URL, in to a campaign, advertisement, media product, or catalog utilizing the aggregated data, and media.

13. The method of claim 1 further comprising the steps of participating in a free barter exchange;
providing semantic keyword finding of potential offers;
reminding the user of potential barters that can be arranged; and
creating a social network advertisement utilizing the aggregated data, and media.

14. The method of claim 1 further comprising the steps of;
making flexible offers to campaigns for placement, collaborations, and promotions, that can change based upon inventory of a tangible or intangible product or service;
adjusting the discount, rebate, or incentive that can change in price; and
publishing merchandise to a web page or a catalog utilizing the aggregated data, and media.

15. The method of claim 1, wherein users can subscribe to, access, and receive suggestions and decisions through a system live requests function creating a software application for a mobile device utilizing the aggregated data, and media.

16. The method of claim 1, further comprising the steps of
selecting a banking institution by a user to have their campaign associated with for transactions in and out of the account as the campaign is in progress and after the campaign is completed;
providing a debit card or voucher by the institution to registered user in the system at the end of the campaign for the campaign funds; or
providing the designated financial services; and
creating a web game utilizing the aggregated data, and media.

17. The method of claim 1, further comprising the steps of
pushing and pulling requests automatically to the campaign user, for assistance in making purchasing decisions during and when the campaign ends; and
providing where voice input or typing input is used for entering a URL of a website into the form utilizing the aggregated data, and media.

18. The method of claim 1, further comprising the steps of
prompting a user when new things change as related to the campaigns providing an animated pointer, spot, or graphic image to make the user aware of changes related to their campaigns;
generating results from a title table in the system server by the website search software application module;
determining a price for each offer based upon how much the advertisement is going to give an associated campaign;
generating the amount of virtual cash offered to a user for using the advertisement; and
generating code that can be pasted into other websites utilizing the aggregated data, and media.

19. The method of claim 1, further comprising the steps of
providing a registered user registers a bar code, QR code, or some other graphical representation of themselves created and stored for fulfillments, references to campaigns, press releases, advertising and marketing;
inputting one or more words with voice input into a form or typing into a form;
extracting all data, media, and images from databases and folders utilizing semantic keyword references;
storing all extracted data in a folder in the database;
processing the data;
determining what data is to be used;
configuring the data for viewing on a web page;
sending URL, website, text, or image information to the form for input; providing options to choose a language for translation or publication of the campaign;
creating a web page; and
creating an advertisement utilizing the aggregated data, and media.

20. The method of claim 1, further comprising the steps of
placing a plurality of sponsors on campaigns when they are started;
charging the first placement a higher advertising rates than the last placement of the advertisements;
setting auctions that are made to sell the higher or lower placements;
inputting the URL of a website page with voice input into a form or typing into a form;
extracting all data, media and images from the URL location of a blog page, or machine generated irrelevant or inappropriate anomaly message web page;
storing all extracted data in a folder in the database;
obtaining blog page, or machine generated irrelevant or inappropriate anomaly message web page owner administrator information;
storing the blog page, or machine generated irrelevant or inappropriate anomaly message web page page owner administrator information in a folder and a database;
processing the data;
determining what data is to be used;
configuring the data for viewing on a web page;
sending URL, website, text, or image information to the form for input;
providing options to choose language, for campaign translation, to publish, make public or private, or print the campaign; and
creating a web page.

21. The method of claim 1, further comprising the steps of:
creating and attaching virtual bank accounts to the registered users account;
setting the value for a first virtual currency,
providing a conversion rate to a second virtual currency;
a first or second virtual currency as an incentive tool in advertisements and campaigns;
trading virtual currencies for tangible and intangible property products;
services for use in a virtual or non-virtual world; and
providing exchange site utilizing the aggregated data, and media.

22. The method in claim 1, further comprising the steps of:
creating a website search software application module;
providing editing and deletion of the software application module;
aggregating from user uploads, resulting from semantic keyword searches performed by user, or digital semantic agent from network, one or more videos;
aggregating from user uploads, resulting from semantic keyword searches performed by user, or digital semantic agent from network, one or more images;
aggregating from user uploads, resulting from semantic keyword searches performed by user, or digital semantic agent from network, one or more catalogs for browsing or shopping;
aggregating from user uploads, resulting from semantic keyword searches performed by user, or digital semantic agent from network, one or more virtual worlds, virtual world places, virtual world objects;
aggregating from user uploads, resulting from semantic keyword searches performed by user, or digital semantic agent from network, one or more websites;
aggregating from user uploads, resulting from semantic keyword searches performed by user, or digital semantic agent from network, one or more social network advertisements;
aggregating from user uploads, resulting from semantic keyword searches performed by user, or digital semantic agent from network, one or more campaigns;
aggregating from user uploads, resulting from semantic keyword searches performed by user, or digital semantic agent from network, one or more advertisements;
aggregating from user uploads, resulting from semantic keyword searches performed by user, or digital semantic agent from network, one or more software applications;
creating, by a code, one or more affiliate software application search modules on a server;
creating the code of the affiliate software search application module from the server;
pasting the code of the affiliate software search application module into a website;
displaying the affiliate software application search module on a website;
generating a commission when a sale occurs through the affiliate software search application module;
providing editing and deletion of the software application module;
creating and transforming one or more previously stored files or data from database aggregated material into one or more of the following;
advertisements;
videos; images;
catalogs for shopping;
virtual world;
virtual world place;
virtual world object;
websites;
social network advertisement;
campaign;
affiliate code;
auction site;
sales site;
software application;
web or software game;
for the purpose of transforming and creating a new user system.

23. The method in claim 1, further comprising the steps of:
utilizing a Human Key for tracking, aggregation, and authentication permissions;
creating digital semantic, and object identification functions; and
further providing the following Human Key steps;
utilizing previously aggregated data for evaluation of permissions;
authentication of a user;
providing shut off control functions;
providing deletion control functions;
providing wireless notification control functions;
providing wireless energy and charging aggregation control functions;
providing camera control functions;
providing audio recording control functions;
providing sensing control functions;
for the purpose of authenticating proper use permissions, managing data, files graphical user interfaces, and machines.
